(19) United States
(12) Patent Application Publication
(10) Pub. No.: US 2019/0097709 A1
(43) Pub. Date: Mar. 28, 2019

(54) COHERENT BEAMFORMING FEEDBACK

(71) Applicant: QUALCOMM Incorporated, San Diego, CA (US)

(72) Inventors: Christoph Joetten, Wadern (DE); Andreas Schenk, Erlangen (DE); Christian Sgraja, Senden (DE)

(21) Appl. No.: 15/713,409

(22) Filed: Sep. 22, 2017

(51) Int. Cl. H04B 7/06; H04B 7/0456

(52) U.S. Cl. CPC H04B 7/0634; H04W 84/12; H04B 7/0617; H04B 7/0456

(57) ABSTRACT

Various aspects of the disclosure relate to ensuring that beamforming feedback is substantially coherent across frequency, time, or some other condition. The disclosure relates in some aspects to generating steering matrix feedback (e.g., at an IEEE 802.11 STA). In some aspects, the generation of the steering matrix feedback uses a singular value decomposition (SVD) algorithm that helps ensure coherence of beamforming feedback. In some aspects, coherence may be achieved by ensuring that the Givens rotations of a matrix are always in the same direction.

### INTRODUCTION

Various aspects described herein relate to wireless communication and, more particularly but not exclusively, to techniques for ensuring that beamforming feedback is substantially coherent across frequency, time, or some other condition.

Wireless communication networks are widely deployed to provide various communication services such as telephony, video, data, messaging, broadcasts, and so on. Such networks, which are usually multiple access networks, support communications for multiple users by sharing the available network resources.

Within such wireless networks a variety of data services may be provided, including voice, video, and emails. More recently, wireless communication networks are being utilized for an even broader range of services and larger numbers of users. As the demand for mobile broadband access continues to increase, research and development continue to advance wireless communication technologies not only to meet the growing demand for mobile broadband access, but to advance and enhance the user experience.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In some aspects, the disclosure provides an apparatus configured for communication. The apparatus includes: a first interface configured to obtain at least one signal from a channel; a processing system configured to: generate a channel matrix from the at least one signal, perform a singular value decomposition operation on the channel matrix to generate singular vectors, wherein the singular value decomposition operation involves selecting a particular Givens rotation from a plurality of Givens rotations to be used for rotating a particular iteration of a channel correlation matrix that is based on the channel matrix, and compress the singular vectors to generate a set of angles; and a second interface configured to output the set of angles for transmission. In some implementations, the first interface and the second interface may correspond to the same interface. For example, an input/output interface (e.g., a transceiver or bus interface) may include a first interface (e.g., an input interface) and a second interface (e.g., an output interface). In some aspects, the disclosure provides a method for communication including: obtaining at least one signal from a channel; generating a channel matrix from the at least one signal; performing a singular value decomposition operation on the channel matrix to generate singular vectors, wherein the singular value decomposition operation involves selecting a particular Givens rotation from a plurality of Givens rotations to be used for rotating a particular iteration of a channel correlation matrix that is based on the channel matrix; compressing the singular vectors to generate a set of angles; and outputting the set of angles for transmission.

In some aspects, the disclosure provides an apparatus configured for communication. The apparatus includes: means for obtaining at least one signal from a channel; means for generating a channel matrix from the at least one signal; means for performing a singular value decomposition operation on the channel matrix to generate singular vectors, wherein the singular value decomposition operation involves selecting a particular Givens rotation from a plurality of Givens rotations to be used for rotating a particular iteration of a channel correlation matrix that is based on the channel matrix; means for compressing the singular vectors to generate a set of angles; and means for outputting the set of angles for transmission.

In some aspects, the disclosure provides a wireless node. The wireless node includes: a receiver configured to receive at least one signal from a channel; a processing system configured to: generate a channel matrix from the at least one signal, perform a singular value decomposition operation on the channel matrix to generate singular vectors, wherein the singular value decomposition operation involves selecting a particular Givens rotation from a plurality of Givens rotations to be used for rotating a particular iteration of a channel correlation matrix that is based on the channel matrix, and compress the singular vectors to generate a set of angles; and a transmitter configured to transmit the set of angles.

In some aspects, the disclosure provides a computer-readable medium (e.g., a non-transitory computer-readable medium) storing computer-executable code, including code to: obtain at least one signal from a channel; generate a channel matrix from the at least one signal; perform a singular value decomposition operation on the channel matrix to generate singular vectors, wherein the singular value decomposition operation involves selecting a particular Givens rotation from a plurality of Givens rotations to be used for rotating a particular iteration of a channel correlation matrix that is based on the channel matrix; compress the singular vectors to generate a set of angles; and output the set of angles for transmission.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 illustrates an example of a wireless communication system in which aspects of the present disclosure may be employed.

FIG. 2 illustrates example feedback angles plotted as a function of the subcarriers in accordance with some aspects of the disclosure.

FIG. 3 illustrates example singular values plotted as a function of the subcarriers in accordance with some aspects of the disclosure.

FIG. 4 illustrates example channel matrix plotted as a function of the subcarriers in accordance with some aspects of the disclosure.

FIG. 5 illustrates an example of a feedback process in accordance with some aspects of the disclosure.

FIG. 6 illustrates another example of a feedback process in accordance with some aspects of the disclosure.

FIG. 7 illustrates another example of a beamforming system in which aspects of the present disclosure may be employed.

FIG. 8 illustrates another example of a wireless communication system in which aspects of the present disclosure may be employed.

FIG. 9 is a functional block diagram of an example apparatus that may be employed within a wireless communication system in accordance with some aspects of the disclosure.

FIG. 10 is a functional block diagram of example components that may be utilized in the apparatus of FIG. 9 to transmit wireless communication.

FIG. 11 is a functional block diagram of example components that may be utilized in the apparatus of FIG. 9 to receive wireless communication.

FIG. 12 is a functional block diagram of an example apparatus in accordance with some aspects of the disclosure.

FIG. 13 is a flow diagram of an example process in accordance with some aspects of the disclosure.

FIG. 14 is a simplified block diagram of sample aspects of an apparatus configured with functionality in accordance with some aspects of the disclosure.

FIG. 15 is a simplified block diagram of sample aspects of a memory configured with code in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method of communication includes

The concepts described herein may be used in an IEEE 802.11-based network (also referred to as a Wi-Fi network), for example, future revisions of the 802.11ax standard or to be developed Wi-Fi standards, or may be used in other types of wireless communication systems. For purposes of illustration, the following may describe various aspects in the context of a Wi-Fi network. It should be appreciated, however, that the teachings herein may be used in other systems as well. Thus, references to functionality in the context of Wi-Fi network terminology should be understood to be equally applicable to other types of technology, networks, components, signaling, and so on.

### Beamforming Feedback

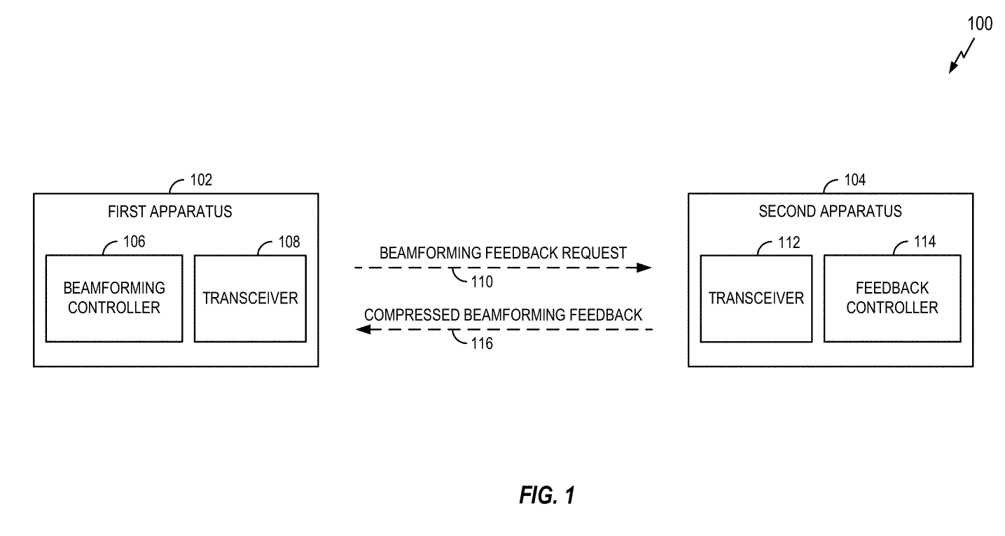

FIG. 1 illustrates a wireless communication system 100 that includes a first apparatus 102 and a second apparatus 104. In practice, a wireless communication system may include a different number of apparatuses.

The first apparatus 102 include a beamforming controller 106 that controls beamformed communication (e.g., transmissions) by a transceiver 108 of the first apparatus 102. To this end, the beamforming controller 106 sends, via the transceiver 108, a beamforming feedback request 110 to the second apparatus 104. After receipt of the beamforming feedback request 110 by a transceiver 112 of the second apparatus 104, a feedback controller 114 generates and compresses the requested feedback. The feedback controller 114 then sends, via the transceiver 112, compressed beamforming feedback 116 to the first apparatus 102. As discussed in more detail below, the feedback controller 114 generates the compressed beamforming feedback so that it is substantially coherent across frequency, time, or some other condition.

In the IEEE 802.11n, 802.11ac, and 802.11ax standards, transmit beamforming (BF) relies on (among other variants) explicit feedback in the form of a compressed steering matrix V and SNR estimates per stream. For example, an access point (AP) may conduct null data packet (NDP) channel sounding and request a station (STA) to send back feedback based on the NDP sounding. The IEEE 802.11 standard, at section 20.3.12.3, discusses these and other aspects of beamforming feedback.

A STA typically computes the matrix V as the right-hand-side singular vectors obtained from a singular value decomposition (SVD) of the channel matrix H, where the channel matrix H is estimated from the NDP channel sounding. The signal-to-noise ratio (SNR) of each beamforming feedback layer is derived from the corresponding singular values of the channel matrix H.

After this SVD operation, the V matrix is compressed into a sequence of unitary rotations described uniquely by the angles phi and psi. The STA feeds these angle values (i.e., the compressed steering matrix V) back to the beamformer, to enable the beamformer to derive the actual steering matrix V to be used for precoding transmissions on the channel In some cases, the STA computed and sends back explicit beamforming feedback for every subcarrier used by the AP.

Conventional SVD algorithms for wireless LAN (WLAN) beamforming feedback implementations do not guarantee coherence across the subcarriers (i.e., in the frequency dimension). However, subcarrier coherence may be beneficial for so-called V-smoothing and can also be exploited to reduce implementation complexity.

### Coherent SVD Algorithm

The disclosure relates in some aspects to a singular value decomposition (SVD) algorithm for ensuring that beamforming feedback is substantially coherent in the frequency domain, the time domain, or some other domain. As used herein, coherence may refer to the matrix V (as well as the angles phi and psi) being smooth across adjacent samples in the respective domains so long as the channel matrix H is smooth across adjacent samples in the same domains. In the frequency domain, coherence may correspond to a matrix V being smooth across adjacent subcarriers, provided that the corresponding channel matrix H is smooth across adjacent subcarriers. For example, the ordering of the singular vectors may change gradually over the subcarriers. This also corresponds to feedback angles phi and psi being smooth across adjacent subcarriers, provided that the channel matrix H is smooth across adjacent subcarriers. In general, the channel matrix H may be smooth for the typical coherence bandwidths of the frequency selective-channels encountered in WLAN (e.g., IEEE 802.11) scenarios. Thus, in general, the term smooth may mean that the corresponding parameters change gradually across subcarriers.

For purposes of illustration, various aspects of the disclosure will be discussed in the context of an algorithm that enables frequency-coherence. However, the teachings herein are also applicable to coherence in any other dimension (e.g., time).

### Example Smoothness Plots

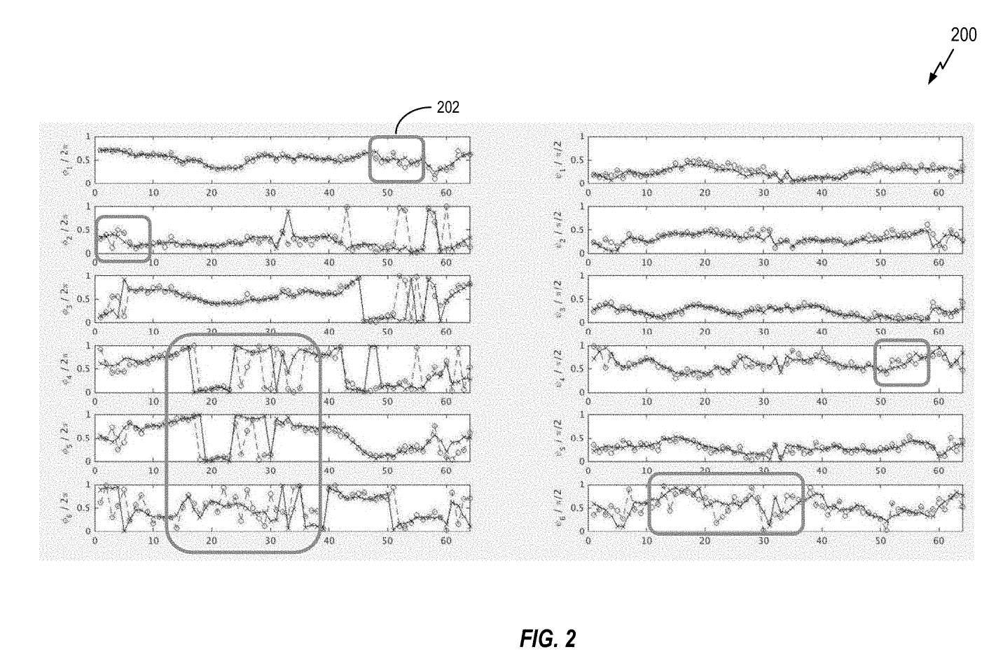

FIGS. 2-4 depict several plots that illustrate examples of smoothness across subcarriers.

The plot 200 of FIG. 2 illustrates an example of channel sounding for 4 transmit antennas/streams and 4 receive antennas for a typical realization of the IEEE channel model D, 20 MHz. For this scenario, the V matrix is compressed into a sequence of 6 angles psi and 6 angles phi, the resulting angles phi and psi are plotted as a function of the subcarrier index. Two variants are compared: the typical state-of-the-art SVD (red) and a frequency-coherent SVD approach in accordance with the teachings herein (blue). The highlighted areas (e.g., the area 202) highlight the most significant deltas between the two variants. Both variants deliver standard-compliant beamforming feedback. The remaining jumps in the plot 200 are a) due to phase wrapping at 2m, and b) due to non-smoothness in the input channel matrix (e.g., around the DC subcarrier, approximately subcarrier 32).

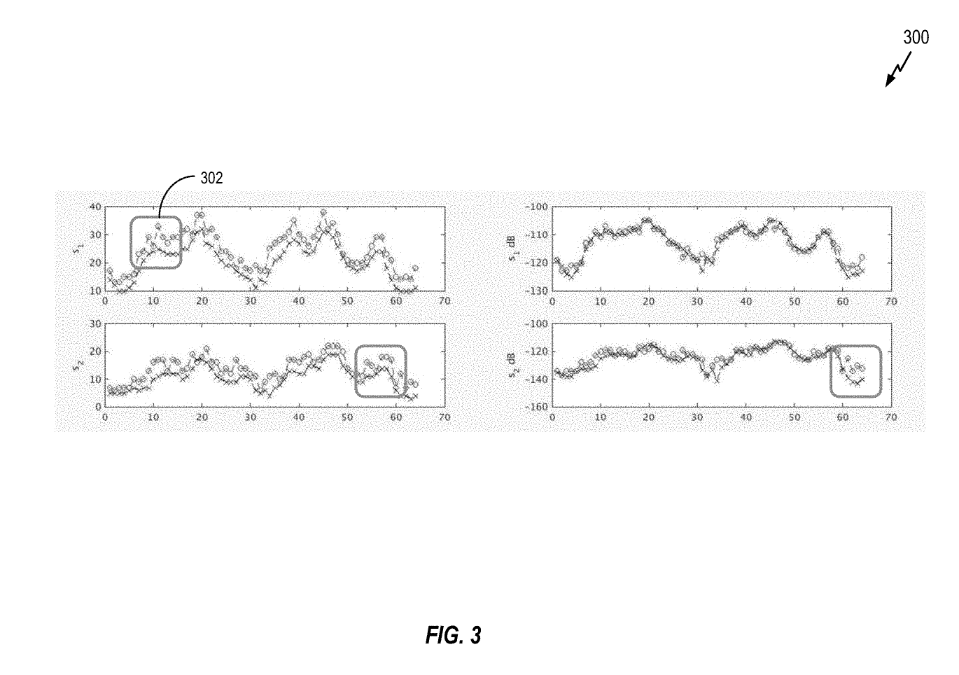

The plot 300 of FIG. 3 illustrates an example of the resulting two relevant singular values (right column: linear scale, left column: dB scale) for the example of FIG. 2. The linear scale singular values are scaled differently in FIG. 3 for better visibility. The highlighted areas (e.g., the area 302) highlight the most significant deltas between the two variants.

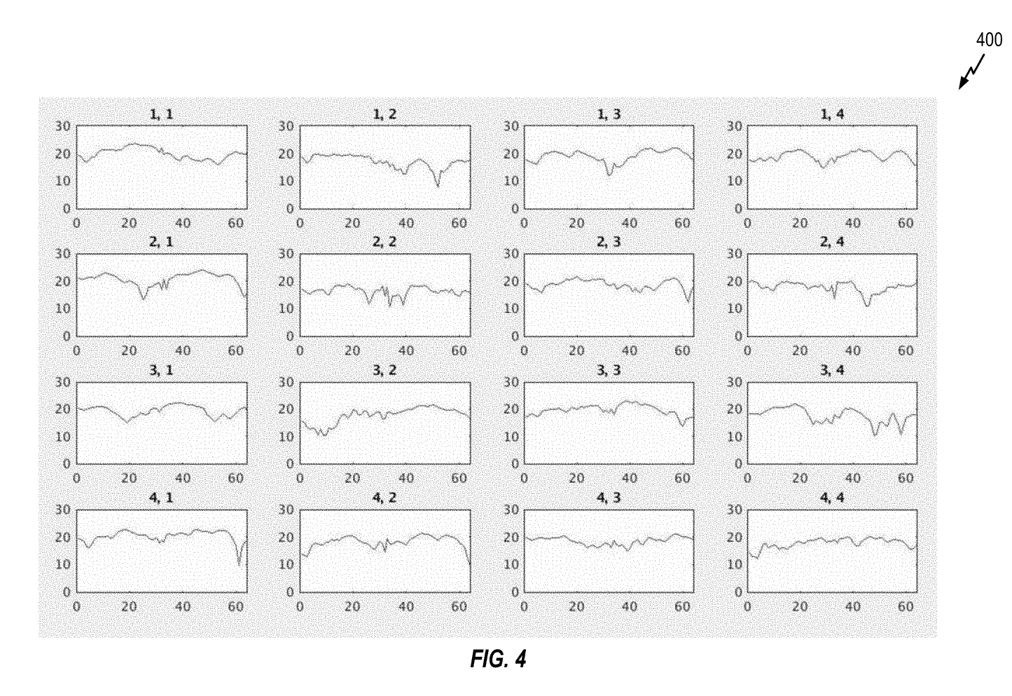

The plot 400 of FIG. 4 illustrates an example of the magnitude in dB of the 4×4 channel matrix H for each channel tap as a function of the subcarriers for the example of FIG. 3. This shows that the channel matrix H is relatively smooth (e.g., except for the jumps at approximately subcarrier 32, etc.).

### Example Implementation

The disclosure relates in some aspects to generating steering matrix feedback (e.g., at an IEEE 802.11 STA). The resulting steering matrices V and angles phi and psi may be compliant to the coordinated beamforming (CBF) report defined in IEEE 802.11.

The use of such an algorithm may provide one or more advantages. For example, the algorithm may result in enhanced performance for 802.11ax in the case of V-matrix smoothing at the beamformer. Also, the use of subsampling feedback computation in the frequency domain may result in a simpler implementation, thereby reducing chip area and/or power consumption. Furthermore, a reduction in beamforming feedback report overhead may be achieved (e.g., in future enhancements of the 802.11 standard) by differentially encoding the angles phi and psi across subcarriers. Moreover, the above may be achieved with only a marginal increase in complexity of the frequency-coherent SVD compared to a typical SVD implementation.

In some aspects, the generation of the steering matrix feedback uses an SVD algorithm that ensures coherence of the feedback as discussed herein. In some aspects, coherence may be achieved by ensuring that the Givens rotations of a matrix are always in the same direction.

An example SVD algorithm derived from the Jacobian eigen-value decomposition algorithm is set forth in Equation 1. The algorithm operates on the channel correlation matrix A=H^{H}H (where .^{H} indicates the Hermitean of a matrix). Over the iterations of the algorithm, V converges to the right-hand-side singular vectors V and A converges to a diagonal matrix with the squared singular values on the main diagonal.

$$[ V A ] = EVD\_Jacobian ( A ) \\ V = I \\ iterate until stopping criterion is met \\ for n = 1 \text{:} {N}_{tx} - 1 \\ for m = n + 1 \text{:} {N}_{tx} \\ W = {I}_{{N}_{tx}} , {W}_{m , m} = {e}^{- j \cdot angle ( {A}_{m , n} )} \\ A = WA {W}^{H} ; V = V \cdot {W}^{H} \\ Ψ = 0.5 \cdot atan ( \frac{2 {A}_{n , m}}{{A}_{m , m} - {A}_{n , n}} ) \\ if {A}_{m , m} < {A}_{n , n} \\ G = {I}_{{N}_{{tx}^{′}}} G ( [ n , m ] , [ n , m ] ) = [ \begin{matrix}cos ( Ψ ) & sin ( Ψ ) \\ - sin ( Ψ ) & cos ( Ψ )\end{matrix} ] \\ else \\ G = {I}_{{{N}_{tx}}^{′}} G ( [ n , m ] , [ n , m ] ) = [ \begin{matrix}sin ( Ψ ) & - cos ( Ψ ) \\ cos ( Ψ ) & sin ( Ψ )\end{matrix} ] \\ end \\ A = {G}^{H} AG \\ V = V \cdot G \\ end \\ end \qquad EQUATION 1$$

The steps to guarantee frequency-coherent processing (the if-else clause) are highlighted in Equation 1. These steps ensure a fixed rotation direction of the Givens rotation matrix G by always choosing the appropriate one of the two possible solutions to the underlying quadratic equation. This fixed rotation direction helps to ensure that similar input matrices result in the same ordering of singular vectors and smoothness of the V matrix. The if-else clause could alternatively be replaced with computing one of the equations and, based on the “if” comparison, conditionally performing a swap on certain results (using known trigonometric equivalence).

Through the use of a coherent SVD algorithm as taught herein, V-matrix smoothing at a beamformer (e.g., an AP) may be improved. IEEE 802.11ax allows the beamformer to smooth the V steering matrices. If the beamforming feedback is already provided in a frequency-smooth/coherent manner due to the use of the coherent SVD algorithm, the efficiency of this additional smoothing at the beamformer is significantly enhanced, leading to higher SNR for the beamformed transmission.

### Example Feedback Interpolation

The disclosure also relates in some aspects to a beamformee (e.g., the above STA) autonomously reducing the number of subcarriers for which an SVD and V-compression needs to be computed. Here, the beamformee may subsample in the frequency domain (e.g., skip every other subcarrier, etc.) if the channel is sufficiently coherent across the subcarriers. For example, given that application of the above SVD algorithm results in the angles phi and psi being smooth across subcarriers, a simple interpolation of the resulting angles phi and psi may be used to compute the feedback for the skipped subcarriers.

For example, given the strict timeline requirements of the channel sounding sequence in 802.11n/ac/ax, compressed beamforming feedback computation may need to be computed for many subcarriers in very short time, which increases overall modem complexity and thus leads to increased chip area and/or power consumption. For example, in the IEEE 802.11 standard, the AP/beamformer may require the beamformee to provide compressed beamforming feedback for all subcarriers in IEEE 802.11ac, and up to every fourth subcarrier in IEEE 802.11ax.

The disclosed algorithm enables the beamformee to autonomously subsample in the frequency domain, and thereby autonomously reduce the number of subcarriers for which an SVD and V-compression needs to be computed. Exploiting the fact that after application of the frequency-coherent SVD algorithm, the angles phi and psi are substantially guaranteed to be smooth across subcarriers, a simple interpolation of the resulting angles phi and psi may be used to compute the feedback for the skipped subcarriers.

Subsampling allows 1) reduced dimensioning of the SVD/compression hardware, thus reducing chip area and/or 2) reduction of clock frequency for the SVD/compression hardware thus reducing modem power consumption. A beamformee could derive the subsampling parameter based on classification of the frequency-selectivity of the channel (more subsampling for less frequency-selective, i.e., flat channels, less subsampling for highly frequency-selective channels).

### Example Incremental Feedback Across Time and Frequency

The teachings herein may advantageously result in more efficient incremental (e.g., delta) beamforming feedback. To decrease the feedback overhead (e.g., the amount of bits used to represent the V matrix in the compressed beamforming report), the smoothness of the reported angles phi and psi of a frequency-coherent SVD algorithm can be exploited.

As an example, the angles phi and psi could be encoded incrementally with lower resolution in angle-deltas across subcarriers as follows: delta_phi[n]=phi[n]-phi[n−1] and delta_psi[n]=psi[n]-psi[n−1], n: subcarrier index. Given the guaranteed smoothness of the angles phi and psi due to the use of the frequency-coherent SVD algorithm, the number of bits required to represent the angle-deltas delta_phi and delta_psi can be smaller than explicit feedback of (quantized) psi[n] and phi[n] used in conventional IEEE 802.11 systems.

### Example Feedback Processes

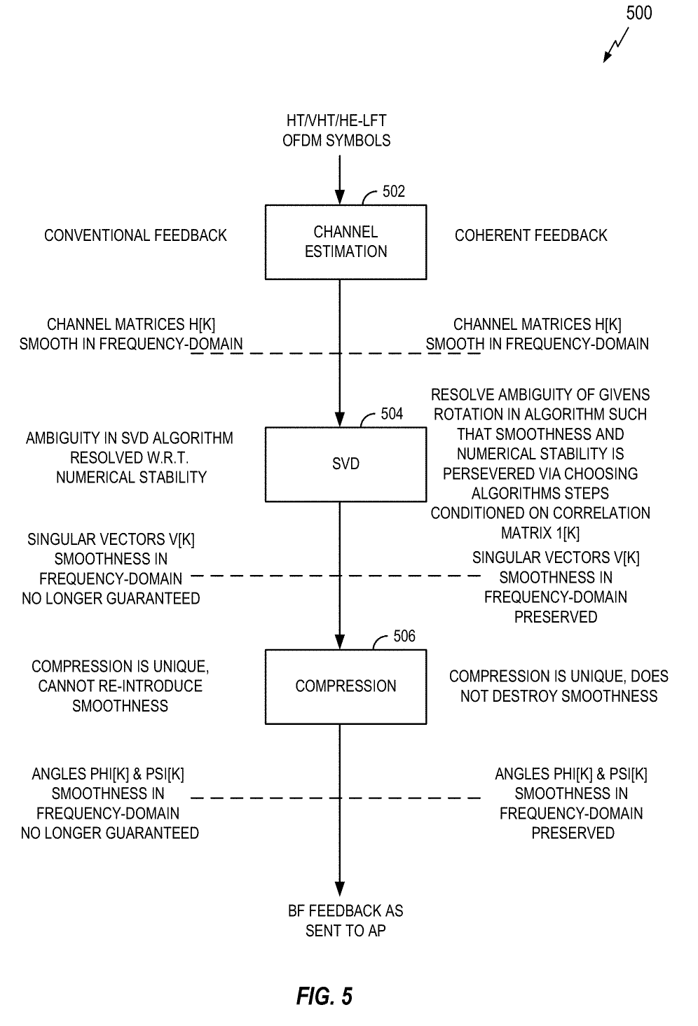

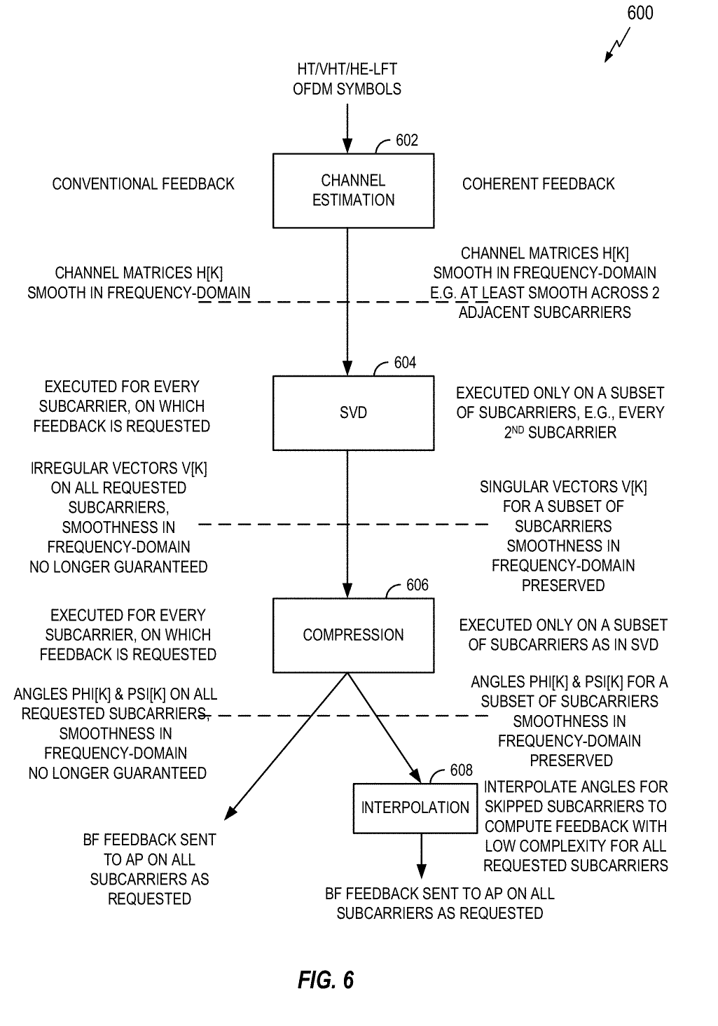

FIGS. 5 and 6 illustrates example feedback processes (e.g., performed by a STA) in accordance with the teachings herein. Each of these figures compares a conventional feedback algorithm (left-hand side) with a coherent SVD feedback algorithm (right-hand side).

Referring initially to FIG. 5, a channel estimation operation 502 performed on symbols received by the STA generates channel matrices. These channel matrices are smooth in the frequency domain.

An SVD operation 504 generates singular vectors based on the channel matrices. With the conventional SVD algorithm, smoothness of the singular vectors in the frequency domain is not guaranteed. In contrast, the coherent SVD feedback algorithm may guarantee (or provide better) smoothness of the singular vectors in the frequency domain.

A compression operation 506 generates the angles phi and psi from the singular vectors. The STA sends these angles as the beamforming feedback to the AP. Since the compression is unique, it cannot re-introduce smoothness that was lost in the conventional SVD algorithm. Consequently, smoothness of the angles in the frequency domain is not guaranteed. On the other hand, the compression does not destroy the smoothness maintained by the coherent SVD feedback algorithm. Consequently, smoothness of the angles in the frequency domain may be guaranteed (or substantially improved) in this case.

FIG. 6 illustrates an example that used interpolation in accordance with the teachings herein. Initially, a channel estimation operation 602 performed on symbols received by the STA generates channel matrices. For the conventional algorithm, these channel matrices are smooth in the frequency domain. For the coherent algorithm, these channel matrices only needs to be smooth in the frequency domain across certain subcarriers.

An SVD operation 604 generates singular vectors based on the channel matrices. With the conventional SVD algorithm, singular vectors are generated for every subcarrier requested by the AP. Again, smoothness of the singular vectors in the frequency domain is not guaranteed. In contrast, with the coherent SVD feedback algorithm, singular vectors are generated for a subset of the subcarriers requested by the AP. Again, the coherent SVD feedback algorithm may guarantee (or provide better) smoothness of the singular vectors in the frequency domain.

A compression operation 606 generates the angles phi and psi from the singular vectors.

With the conventional SVD algorithm, compression is performed on the vectors for every subcarrier requested by the AP. The STA sends these angles for all requested subcarriers as the beamforming feedback to the AP. As discussed above, since the compression is unique, it cannot re-introduce smoothness that was lost in the conventional SVD algorithm. Consequently, smoothness of the angles in the frequency domain is not guaranteed.

In contrast, with the coherent SVD feedback algorithm, compression only need be applied to the singular vectors generated for a subset of the subcarriers requested by the AP. In this case, an interpolation operation is used to compute the angles for the subcarriers that were skipped. The STA can therefor send angles for all requested subcarriers as the beamforming feedback to the AP. The compression and interpolation does not destroy the smoothness maintained by the coherent SVD feedback algorithm. Consequently, smoothness of the angles in the frequency domain may be guaranteed (or substantially improved) in this case.

### Wireless Communication Examples

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≤min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also comprise, be implemented as, or known as a Transmit Receive Point (TRP), a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, a client, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus may include an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3^{rd} Generation Partnership Project” (3GPP), while cdma2000 is described in documents from an organization named “3^{rd} Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1×RTT, 1×EV-DO Rel0, RevA, RevB) technology and other technologies.

### Example Beamforming System

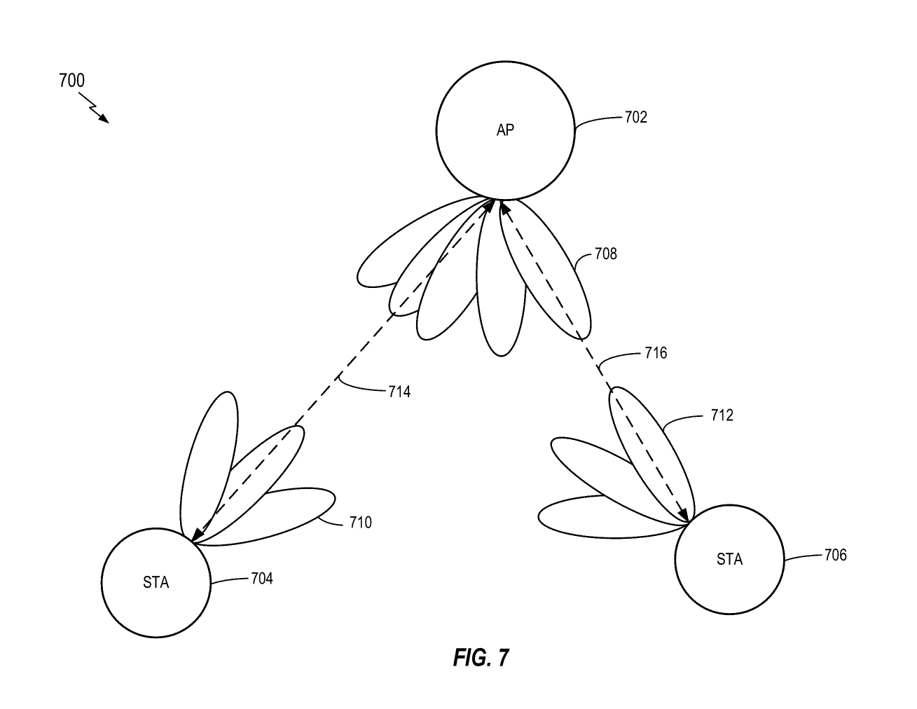

FIG. 7 illustrates a communication system 700 where an access point (AP) 702 communicates with a first STA 704 and a second STA 706 via different beamforming directions. As indicated by a set of beams 708, the AP 702 may communicate via any one of a plural of directional beams. As indicated by a set of beams 710, the first STA 704 may communicate via any one of a plural of directional beams. As indicated by a set of beams 712, the second STA 706 may communicate via any one of a plural of directional beams. For example, the AP 702 may communicate with the first STA 704 via a first beamforming direction 714 and communicate with the second STA 706 via a second beamforming direction 716.

A wireless MIMO system may use multiple transmit antennas to provide beamforming-based signal transmission. Typically, beamforming-based signals transmitted from different antennas are adjusted in phase (and optionally amplitude) such that the resulting signal power is focused toward a receiver device (e.g., an access terminal).

A wireless MIMO system may support communication for a single user at a time or for several users concurrently. Transmissions to a single user (e.g., a single receiver device) are commonly referred to as single-user MIMO (SU-MIMO), while concurrent transmissions to multiple users are commonly referred to as multi-user MIMO (MU-MIMO).

MIMO may be used in a wireless local area network (WLAN) that supports IEEE 802.11ax or some other 802.11-based standard. An AP (e.g., a base station) of an 802.11-based MIMO system employs multiple antennas for data transmission and reception, while each user station (STA) employs one or more antennas. The AP communicates with the STAs via forward link channels and reverse link channels. In some aspects, a downlink (DL) channel refers to a communication channel from a transmit antenna of the access point to a receive antenna of a STA, and an uplink (UL) channel refers to a communication channel from a transmit antenna of a STA to a receive antenna of the AP. Downlink and uplink may be referred to as forward link and reverse link, respectively.

MIMO channels corresponding to transmissions from a set of transmit antennas to a receive antenna are referred to spatial streams since precoding (e.g., beamforming) is employed to direct the transmissions toward the receive antenna. Consequently, in some aspects each spatial stream corresponds to at least one dimension. A MIMO system thus provides improved performance (e.g., higher throughput and/or greater reliability) through the use of the additional dimensionalities provided by these spatial streams.

### Example Wireless Communication System

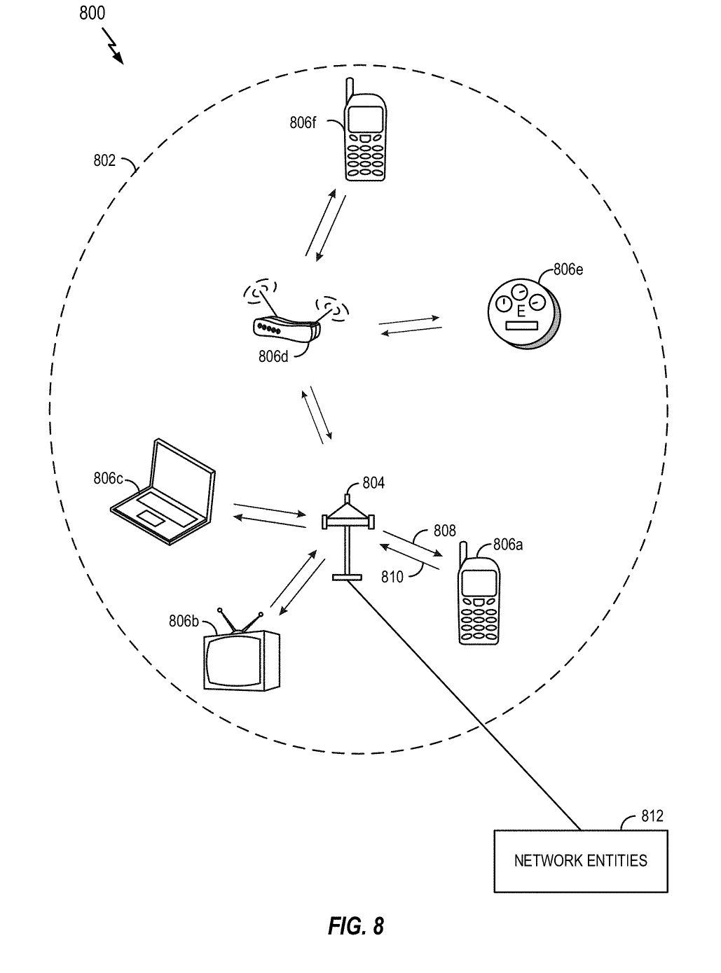

FIG. 8 illustrates an example of a wireless communication system 800 in which aspects of the present disclosure may be employed. The wireless communication system 800 may operate pursuant to a wireless standard, for example the 802.11 standard. The wireless communication system 800 may include an AP 804, which communicates with STAs 806a, 806b, 806c, 806d, 806e, and 806f (collectively STAs 806).

STAs 806e and 806f may have difficulty communicating with the AP 804 or may be out of range and unable to communicate with the AP 804. As such, another STA 806d may be configured as a relay device (e.g., a device comprising STA and AP functionality) that relays communication between the AP 804 and the STAs 806e and 806f.

A variety of processes and methods may be used for transmissions in the wireless communication system 800 between the AP 804 and the STAs 806. For example, signals may be sent and received between the AP 804 and the STAs 806 in accordance with OFDM/OFDMA techniques. If this is the case, the wireless communication system 800 may be referred to as an OFDM/OFDMA system. Alternatively, signals may be sent and received between the AP 804 and the STAs 806 in accordance with CDMA techniques. If this is the case, the wireless communication system 800 may be referred to as a CDMA system.

A communication link that facilitates transmission from the AP 804 to one or more of the STAs 806 may be referred to as a downlink (DL) 808, and a communication link that facilitates transmission from one or more of the STAs 806 to the AP 804 may be referred to as an uplink (UL) 810. Alternatively, a downlink 808 may be referred to as a forward link or a forward channel, and an uplink 810 may be referred to as a reverse link or a reverse channel.

The AP 804 may act as a base station and provide wireless communication coverage in a basic service area (BSA) 802. The AP 804 along with the STAs 806 associated with the AP 804 and that use the AP 804 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 804 or to some other access point in the network (not shown).

Each of the access points may communicate with one or more network entities (represented, for convenience, by network entities 812 in FIG. 8), including each other, to facilitate wide area network connectivity. A network entity may take various forms such as, for example, one or more radio and/or core network entities. Thus, in various implementations the network entities 812 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 800 might not have a central AP 804, but rather may function as a peer-to-peer network between the STAs 806. Accordingly, the functions of the AP 804 described herein may alternatively be performed by one or more of the STAs 806. Also, as mentioned above, a relay may incorporate at least some of the functionality of an AP and a STA.

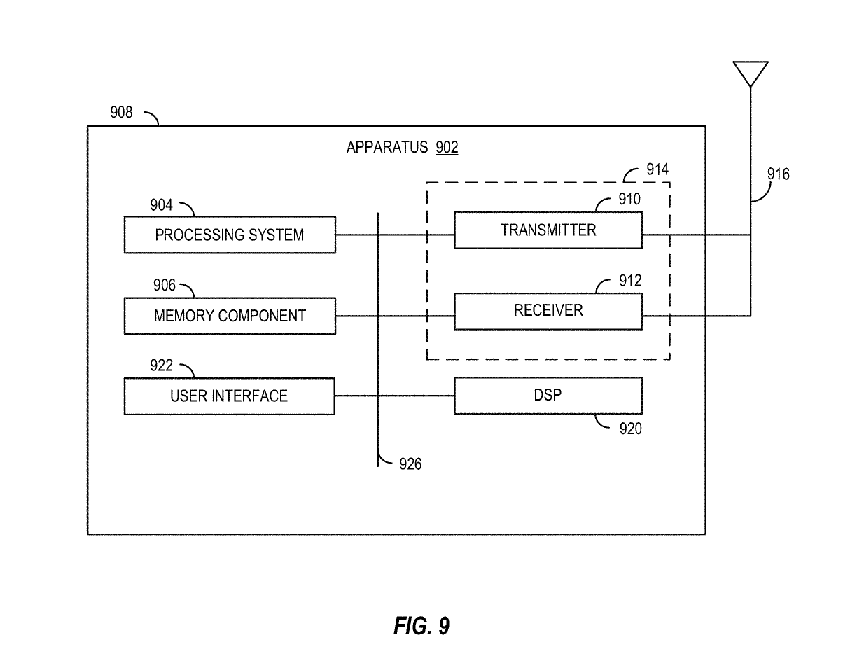

FIG. 9 illustrates various components that may be utilized in an apparatus 902 (e.g., a wireless device) that may be employed within the wireless communication system 800. The apparatus 902 is an example of a device that may be configured to implement the various methods described herein. For example, the apparatus 902 may comprise the AP 804, a relay (e.g., the STA 806d), or one of the STAs 806 of FIG. 8.

The apparatus 902 may include a processing system 904 that controls operation of the apparatus 902. The processing system 904 may also be referred to as a central processing unit (CPU). A memory component 906 (e.g., including a memory device), which may include both read-only memory (ROM) and random access memory (RAM), provides instructions and data to the processing system 904. A portion of the memory component 906 may also include non-volatile random access memory (NVRAM). The processing system 904 typically performs logical and arithmetic operations based on program instructions stored within the memory component 906. The instructions in the memory component 906 may be executable to implement the methods described herein.

When the apparatus 902 is implemented or used as a transmitting node, the processing system 904 may be configured to select one of a plurality of media access control (MAC) header types, and to generate a packet having that MAC header type. For example, the processing system 904 may be configured to generate a packet comprising a MAC header and a payload and to determine what type of MAC header to use.

When the apparatus 902 is implemented or used as a receiving node, the processing system 904 may be configured to process packets of a plurality of different MAC header types. For example, the processing system 904 may be configured to determine the type of MAC header used in a packet and process the packet and/or fields of the MAC header.

The processing system 904 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 902 may also include a housing 908 that may include a transmitter 910 and a receiver 912 to allow transmission and reception of data between the apparatus 902 and a remote location. The transmitter 910 and receiver 912 may be combined into single communication device (e.g., a transceiver 914). An antenna 916 may be attached to the housing 908 and electrically coupled to the transceiver 914. The apparatus 902 may also include (not shown) multiple transmitters, multiple receivers, multiple transceivers, and/or multiple antennas. A transmitter 910 and a receiver 912 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 910 may be configured to wirelessly transmit packets having different MAC header types. For example, the transmitter 910 may be configured to transmit packets with different types of headers generated by the processing system 904, discussed above.

The receiver 912 may be configured to wirelessly receive packets having different MAC header type. In some aspects, the receiver 912 is configured to detect a type of a MAC header used and process the packet accordingly.

The receiver 912 may be used to detect and quantify the level of signals received by the transceiver 914. The receiver 912 may detect such signals as total energy, energy per subcarrier per symbol, power spectral density and other signals. The apparatus 902 may also include a digital signal processor (DSP) 920 for use in processing signals. The DSP 920 may be configured to generate a data unit for transmission. In some aspects, the data unit may comprise a physical layer data unit (PPDU). In some aspects, the PPDU is referred to as a packet.

The apparatus 902 may further comprise a user interface 922 in some aspects. The user interface 922 may comprise a keypad, a microphone, a speaker, and/or a display. The user interface 922 may include any element or component that conveys information to a user of the apparatus 902 and/or receives input from the user.

The various components of the apparatus 902 may be coupled together by a bus system 926. The bus system 926 may include a data bus, for example, as well as a power bus, a control signal bus, and a status signal bus in addition to the data bus. Those of skill in the art will appreciate the components of the apparatus 902 may be coupled together or accept or provide inputs to each other using some other mechanism.

Although a number of separate components are illustrated in FIG. 9, one or more of the components may be combined or commonly implemented. For example, the processing system 904 may be used to implement not only the functionality described above with respect to the processing system 904, but also to implement the functionality described above with respect to the transceiver 914 and/or the DSP 920. Further, each of the components illustrated in FIG. 9 may be implemented using a plurality of separate elements. Furthermore, the processing system 904 may be used to implement any of the components, modules, circuits, or the like described below, or each may be implemented using a plurality of separate elements.

For ease of reference, when the apparatus 902 is configured as a transmitting node, it is hereinafter referred to as an apparatus 902t. Similarly, when the apparatus 902 is configured as a receiving node, it is hereinafter referred to as an apparatus 902r. A device in the wireless communication system 800 may implement only functionality of a transmitting node, only functionality of a receiving node, or functionality of both a transmitting node and a receive node.

As discussed above, the apparatus 902 may comprise an AP 804 or a STA 806, and may be used to transmit and/or receive communication having a plurality of MAC header types.

The components of FIG. 9 may be implemented in various ways. In some implementations, the components of FIG. 9 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 9 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

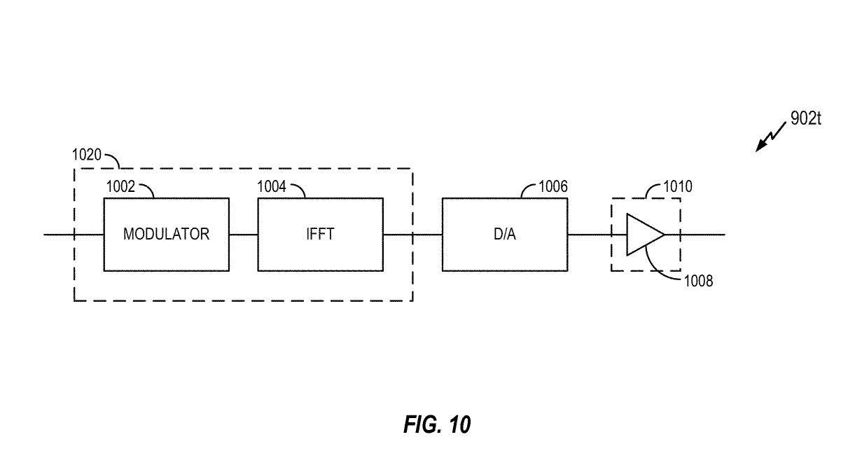

As discussed above, the apparatus 902 may comprise an AP 804 or a STA 806, a relay, or some other type of apparatus, and may be used to transmit and/or receive communication. FIG. 10 illustrates various components that may be utilized in the apparatus 902t to transmit wireless communication. The components illustrated in FIG. 10 may be used, for example, to transmit OFDM communication. In some aspects, the components illustrated in FIG. 10 are used to generate and transmit packets to be sent over a bandwidth of less than or equal to 1 MHz.

The apparatus 902t of FIG. 10 may comprise a modulator 1002 configured to modulate bits for transmission. For example, the modulator 1002 may determine a plurality of symbols from bits received from the processing system 904 (FIG. 9) or the user interface 922 (FIG. 9), for example by mapping bits to a plurality of symbols according to a constellation. The bits may correspond to user data or to control information. In some aspects, the bits are received in codewords. In one aspect, the modulator 1002 may comprise a QAM (quadrature amplitude modulation) modulator, for example, a 16-QAM modulator or a 64-QAM modulator. In other aspects, the modulator 1002 may comprise a binary phase-shift keying (BPSK) modulator, a quadrature phase-shift keying (QPSK) modulator, or an 8-PSK modulator.

The apparatus 902t may further comprise a transform module 1004 configured to convert symbols or otherwise modulated bits from the modulator 1002 into a time domain. In FIG. 10, the transform module 1004 is illustrated as being implemented by an inverse fast Fourier transform (IFFT) module. In some implementations, there may be multiple transform modules (not shown) that transform units of data of different sizes. In some implementations, the transform module 1004 may be itself configured to transform units of data of different sizes. For example, the transform module 1004 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 1004 may be referred to as the size of the transform module 1004.

In FIG. 10, the modulator 1002 and the transform module 1004 are illustrated as being implemented in the DSP 1020. In some aspects, however, one or both of the modulator 1002 and the transform module 1004 are implemented in the processing system 904 or in another element of the apparatus 902t (e.g., see description above with reference to FIG. 9).

As discussed above, the DSP 1020 may be configured to generate a data unit for transmission. In some aspects, the modulator 1002 and the transform module 1004 may be configured to generate a data unit comprising a plurality of fields including control information and a plurality of data symbols.

Returning to the description of FIG. 10, the apparatus 902t may further comprise a digital to analog converter 1006 configured to convert the output of the transform module into an analog signal. For example, the time-domain output of the transform module 1004 may be converted to a baseband OFDM signal by the digital to analog converter 1006. The digital to analog converter 1006 may be implemented in the processing system 904 or in another element of the apparatus 902 of FIG. 9. In some aspects, the digital to analog converter 1006 is implemented in the transceiver 914 (FIG. 9) or in a data transmit processor.

The analog signal may be wirelessly transmitted by the transmitter 1010. The analog signal may be further processed before being transmitted by the transmitter 1010, for example by being filtered or by being upconverted to an intermediate or carrier frequency. In the aspect illustrated in FIG. 10, the transmitter 1010 includes a transmit amplifier 1008. Prior to being transmitted, the analog signal may be amplified by the transmit amplifier 1008. In some aspects, the amplifier 1008 may include a low noise amplifier (LNA).

The transmitter 1010 is configured to transmit one or more packets or data units in a wireless signal based on the analog signal. The data units may be generated using the processing system 904 (FIG. 9) and/or the DSP 1020, for example using the modulator 1002 and the transform module 1004 as discussed above. Data units that may be generated and transmitted as discussed above are described in additional detail below.

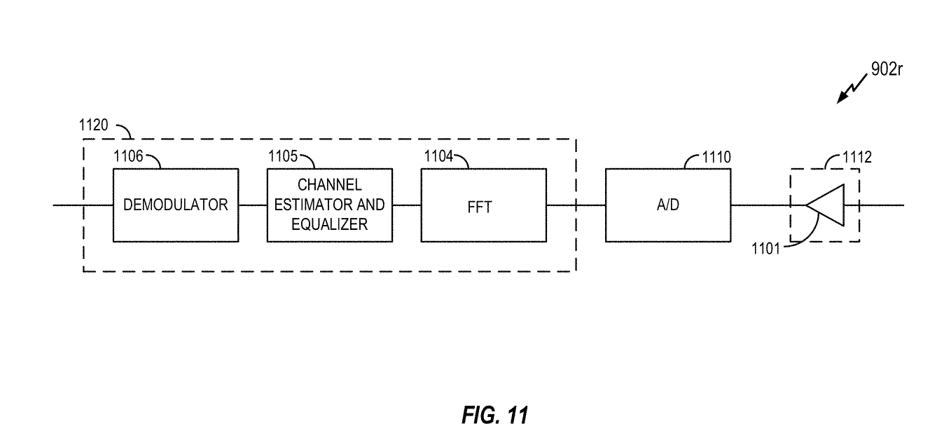

FIG. 11 illustrates various components that may be utilized in the apparatus 902 of FIG. 9 to receive wireless communication. The components illustrated in FIG. 11 may be used, for example, to receive OFDM communication. For example, the components illustrated in FIG. 11 may be used to receive data units transmitted by the components discussed above with respect to FIG. 10.

The receiver 1112 of apparatus 902r is configured to receive one or more packets or data units in a wireless signal. Data units that may be received and decoded or otherwise processed as discussed below.

In the aspect illustrated in FIG. 11, the receiver 1112 includes a receive amplifier 1101. The receive amplifier 1101 may be configured to amplify the wireless signal received by the receiver 1112. In some aspects, the receiver 1112 is configured to adjust the gain of the receive amplifier 1101 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1101 may include an LNA.

The apparatus 902r may comprise an analog to digital converter 1110 configured to convert the amplified wireless signal from the receiver 1112 into a digital representation thereof. Further to being amplified, the wireless signal may be processed before being converted by the analog to digital converter 1110, for example by being filtered or by being downconverted to an intermediate or baseband frequency. The analog to digital converter 1110 may be implemented in the processing system 904 (FIG. 9) or in another element of the apparatus 902r. In some aspects, the analog to digital converter 1110 is implemented in the transceiver 914 (FIG. 9) or in a data receive processor.

The apparatus 902r may further comprise a transform module 1104 configured to convert the representation of the wireless signal into a frequency spectrum. In FIG. 11, the transform module 1104 is illustrated as being implemented by a fast Fourier transform (FFT) module. In some aspects, the transform module may identify a symbol for each point that it uses. As described above with reference to FIG. 10, the transform module 1104 may be configured with a plurality of modes, and may use a different number of points to convert the signal in each mode. The number of points used by the transform module 1104 may be referred to as the size of the transform module 1104. In some aspects, the transform module 1104 may identify a symbol for each point that it uses.

The apparatus 902r may further comprise a channel estimator and equalizer 1105 configured to form an estimate of the channel over which the data unit is received, and to remove certain effects of the channel based on the channel estimate. For example, the channel estimator and equalizer 1105 may be configured to approximate a function of the channel, and the channel equalizer may be configured to apply an inverse of that function to the data in the frequency spectrum.

The apparatus 902r may further comprise a demodulator 1106 configured to demodulate the equalized data. For example, the demodulator 1106 may determine a plurality of bits from symbols output by the transform module 1104 and the channel estimator and equalizer 1105, for example by reversing a mapping of bits to a symbol in a constellation. The bits may be processed or evaluated by the processing system 904 (FIG. 9), or used to display or otherwise output information to the user interface 922 (FIG. 9). In this way, data and/or information may be decoded. In some aspects, the bits correspond to codewords. In one aspect, the demodulator 1106 may include a QAM (quadrature amplitude modulation) demodulator, for example an 8-QAM demodulator or a 64-QAM demodulator. In other aspects, the demodulator 1106 may include a binary phase-shift keying (BPSK) demodulator or a quadrature phase-shift keying (QPSK) demodulator.

In FIG. 11, the transform module 1104, the channel estimator and equalizer 1105, and the demodulator 1106 are illustrated as being implemented in the DSP 1120. In some aspects, however, one or more of the transform module 1104, the channel estimator and equalizer 1105, and the demodulator 1106 are implemented in the processing system 904 (FIG. 9) or in another element of the apparatus 902 (FIG. 9).

As discussed above, the wireless signal received at the receiver 912 may include one or more data units. Using the functions or components described above, the data units or data symbols therein may be decoded evaluated or otherwise evaluated or processed. For example, the processing system 904 (FIG. 9) and/or the DSP 1120 may be used to decode data symbols in the data units using the transform module 1104, the channel estimator and equalizer 1105, and the demodulator 1106.

Data units exchanged by the AP 804 and the STA 806 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 902t shown in FIG. 10 is an example of a single transmit chain used for transmitting via an antenna. The apparatus 902r shown in FIG. 11 is an example of a single receive chain used for receiving via an antenna. In some implementations, the apparatus 902t or 902r may implement a portion of a MIMO system using multiple antennas to simultaneously transmit data.

The wireless communication system 800 may employ methods to allow efficient access of the wireless medium based on unpredictable data transmissions while avoiding collisions. As such, in accordance with various aspects, the wireless communication system 800 performs carrier sense multiple access/collision avoidance (CSMA/CA) that may be referred to as the Distributed Coordination Function (DCF). More generally, an apparatus 902 having data for transmission senses the wireless medium to determine if the channel is already occupied. If the apparatus 902 senses the channel is idle, then the apparatus 902 transmits prepared data. Otherwise, the apparatus 902 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel

A wireless apparatus may include various components that perform functions based on signals that are transmitted by or received at the wireless apparatus. For example, in some implementations a wireless apparatus may include a user interface configured to output an indication based on a received signal as taught herein.

### Example Communication Device

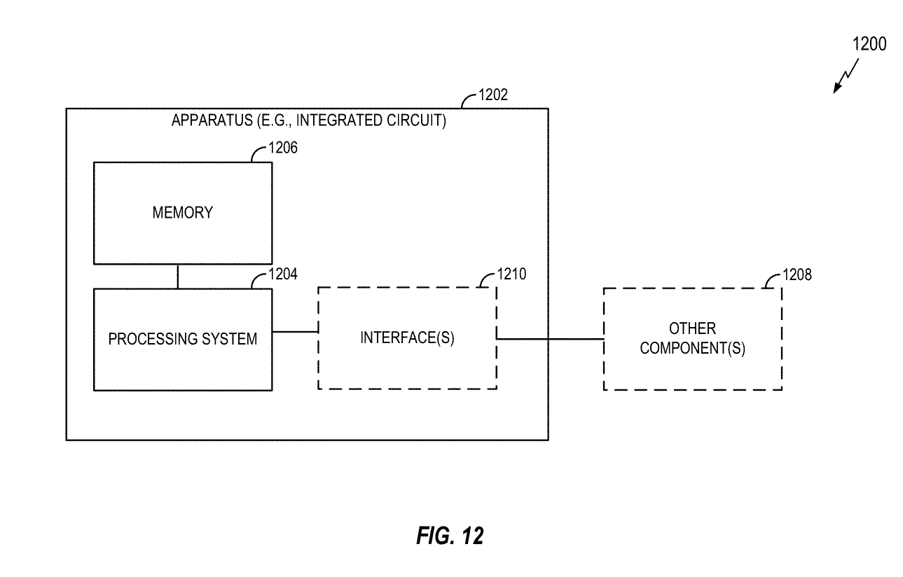

FIG. 12 illustrates an example apparatus 1200 (e.g., an AP, an AT, or some other type of wireless communication node) according to certain aspects of the disclosure. The apparatus 1200 includes an apparatus 1202 (e.g., an integrated circuit) and, optionally, at least one other component 1208. In some aspects, the apparatus 1202 may be configured to operate in a wireless communication node (e.g., an AP or an AT) and to perform one or more of the operations described herein. For convenience, a wireless communication node may be referred to herein as a wireless node. The apparatus 1202 includes a processing system 1204, and a memory 1206 coupled to the processing system 1204. Example implementations of the processing system 1204 are provided herein. In some aspects, the processing system 1204 and the memory 1206 of FIG. 12 may correspond to the processing system 904 and the memory component 906 of FIG. 9.

The processing system 1204 is generally adapted for processing, including the execution of such programming stored on the memory 1206. For example, the memory 1206 may store instructions that, when executed by the processing system 1204, cause the processing system 1204 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some implementations, the apparatus 1202 communicates with at least one other component (e.g., a component 1208 external to the apparatus 1202) of the apparatus 1200. To this end, in some implementations, the apparatus 1202 may include at least one interface 1210 (e.g., a send/receive interface) coupled to the processing system 1204 for outputting and/or obtaining (e.g., sending and/or receiving) information (e.g., received information, generated information, decoded information, messages, etc.) between the processing system 1204 and the other component 1208. In some implementations, the interface 1210 may include an interface bus, bus drivers, bus receivers, other suitable circuitry, or a combination thereof. In some implementations, the interface 1210 may include radio frequency (RF) circuitry (e.g., an RF transmitter and/or an RF receiver). In some implementations, the interface 1210 may be configured to interface the apparatus 1202 to one or more other components of the apparatus 1200 (other components not shown in FIG. 12). For example, the interface 1210 may be configured to interface the processing system 1204 to a radio frequency (RF) front end (e.g., an RF transmitter and/or am RF receiver).

The apparatus 1202 may communicate with other apparatuses in various ways. In cases where the apparatus 1202 includes an RF transceiver (not shown in FIG. 12), the apparatus may transmit and receive information (e.g., a frame, a message, bits, etc.) via RF signaling. In some cases, rather than transmitting information via RF signaling, the apparatus 1202 may have an interface to provide (e.g., output, send, transmit, etc.) information for RF transmission. For example, the processing system 1204 may output information, via a bus interface, to an RF front end for RF transmission. Similarly, rather than receiving information via RF signaling, the apparatus 1202 may have an interface to obtain information that is received by another apparatus. For example, the processing system 1204 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

### Example Process

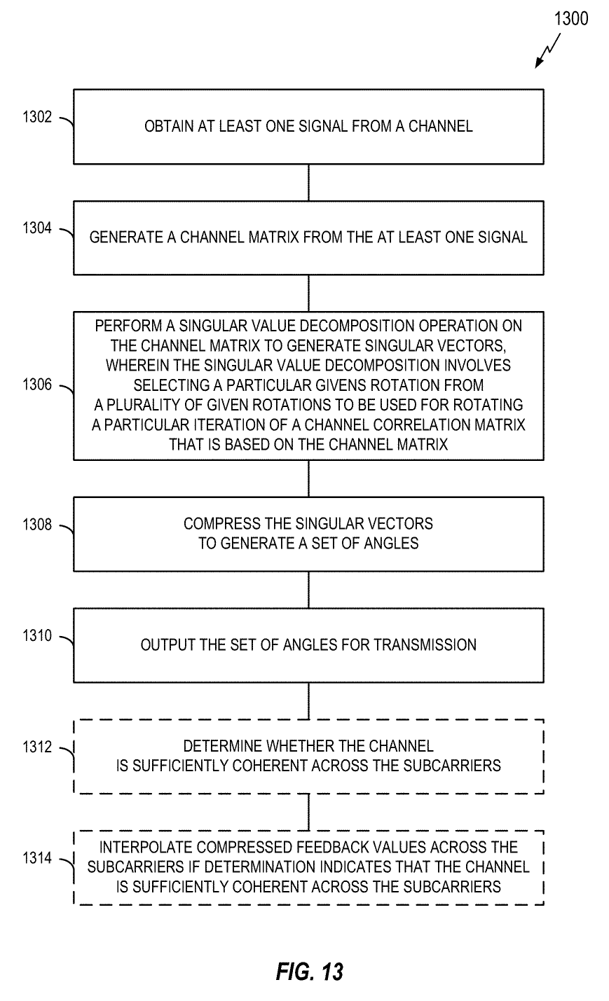

FIG. 13 illustrates a process 1300 for communication in accordance with some aspects of the disclosure. The process 1300 may take place within a processing system (e.g., the processing system 1204 of FIG. 12), which may be located in a STA, an AP, or some other suitable apparatus. Of course, in various aspects within the scope of the disclosure, the process 1300 may be implemented by any suitable apparatus capable of supporting communication-related operations.

At block 1302, an apparatus (e.g., a chip of a receiving wireless node) obtains at least one signal from a channel (e.g., from NDP channel sounding). At block 1304, the apparatus generates a channel matrix (e.g., channel matrix H) from the at least one signal.

At block 1306, the apparatus performs a singular value decomposition operation on the channel matrix to generate singular vectors. In some aspects, the singular value decomposition may involve selecting a particular Givens rotation from a plurality of Givens rotations to be used for rotating a particular iteration of a channel correlation matrix that is based on the channel matrix. For example, the apparatus may perform the operations of Equation 1 set forth above. In some aspects, by selecting the particular Givens rotation, the apparatus may generate the set of angles with frequency coherence across a plurality of subcarriers of the channel.

The selection of the particular Givens rotation may take various forms. In some aspects, the selection of the particular Givens rotation may include ensuring that all of the rotations of the channel correlation matrix are in the same direction. In some aspects, the selection of the particular Givens rotation may include comparing a first magnitude of a first diagonal element of the particular iteration of the channel correlation matrix with a second magnitude of a second diagonal element of the particular iteration of the channel correlation matrix. In some aspects, the selection of the particular Givens rotation may include selecting a first one of the plurality of Givens rotations if the comparison indicates that the first magnitude is less than the second magnitude; and selecting a second one of the plurality of Givens rotations if the comparison indicates that the first magnitude is greater than or equal to the second magnitude. In some aspects, the selection of the particular Givens rotation may include selecting one of two solutions to a quadratic equation corresponding to the Givens rotations. In some aspects, a first one of the plurality of Givens rotations may include (e.g., may be):

$$[ \begin{matrix}cos ψ & sin ψ \\ - sin ψ & cos ψ\end{matrix} ] ,$$

while a second one of the plurality of Givens rotations may include (e.g., may be):

$$[ \begin{matrix}sin ψ & - cos ψ \\ cos ψ & sin ψ\end{matrix} ] .$$

At block 1308, the apparatus compresses the singular vectors to generate a set of angles. In some aspects, the set of angles may include sets of phi and psi values. For example, the apparatus may compress a steering matrix V to generate psi and phi angle values.

At block 1310, the apparatus outputs the set of angles for transmission.

At optional block 1312, the apparatus may determine whether the channel is sufficiently coherent across a plurality of subcarriers of the channel.

At optional block 1314, the apparatus may interpolate between at least two angles of the set of angles across the subcarriers to generate at least one interpolated angle if the determination of block 1312 indicates that the channel is sufficiently coherent across the subcarriers. In this case, the apparatus may also output the at least one interpolated angle for transmission (e.g., at block 1310).

In some aspects, the process 1300 may include any combination of the above features.

### Example Apparatus

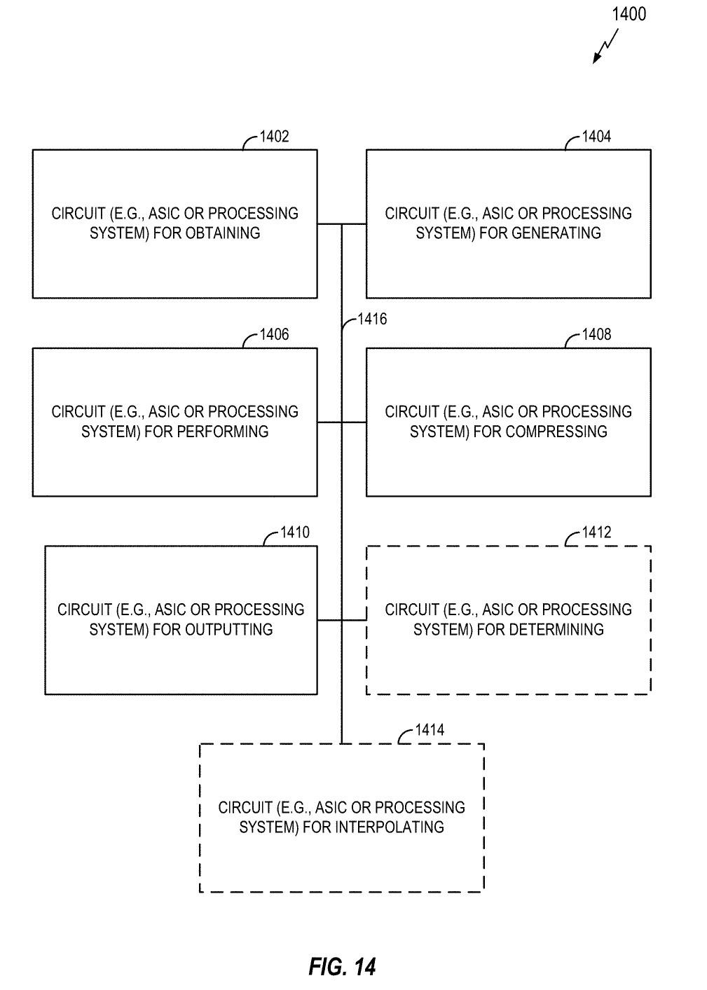

The components described herein may be implemented in a variety of ways. Referring to FIG. 14, an apparatus 1400 is represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1400 includes one or more components (modules) that may perform one or more of the functions described herein with regard to various figures. For example, a circuit (e.g., an ASIC or processing system) for obtaining 1402, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for generating 1404, e.g., a means for generating, may correspond to, for example, a processing system as discussed herein. A circuit (e.g., an ASIC or processing system) for performing 1406, e.g., a means for performing, may correspond to, for example, a processing system as discussed herein. A circuit (e.g., an ASIC or processing system) for compressing 1408, e.g., a means for compressing, may correspond to, for example, a processing system as discussed herein. A circuit (e.g., an ASIC or processing system) for outputting 1410, e.g., a means for outputting, may correspond to, for example, an interface (e.g., a bus interface, a send/receive interface, or some other type of signal interface), a communication device, a transceiver, a transmitter, or some other similar component as discussed herein. A circuit (e.g., an ASIC or processing system) for determining 1412, e.g., a means for determining, may correspond to, for example, a processing system as discussed herein. A circuit (e.g., an ASIC or processing system) for interpolating 1414, e.g., a means for interpolating, may correspond to, for example, a processing system as discussed herein. Two or more of the modules of FIG. 14 may communicate with each other or some other component via a signaling bus 1414. In various implementations, the processing system 904 of FIG. 9 and/or the processing system 1204 of FIG. 12 may include one or more of the circuit for obtaining 1402, the circuit for generating 1404, the circuit for performing 1406, the circuit for compressing 1408, the circuit for outputting 1410, the circuit for determining 1412, or the circuit for interpolating 1414.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes herein are optional.

As noted above, the apparatus 1400 may include one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1400 may comprise a single device (e.g., with components 1402-1414 comprising different sections of an ASIC). As another specific example, the apparatus 1400 may comprise several devices (e.g., with the components 1402 and 1410 comprising one ASIC, and the components 1404-1408, 1412, and 1414 comprising another ASIC).

In addition, the components and functions represented by FIG. 14 as well as other components and functions described herein, may be implemented using any suitable means. Such means are implemented, at least in part, using corresponding structure as taught herein. For example, the components described above in conjunction with the “ASIC for” components of FIG. 14 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the process 1300 illustrated in FIG. 13 may correspond at least in some aspects, to corresponding blocks of the apparatus 1400 illustrated in FIG. 14.

### Example Programming

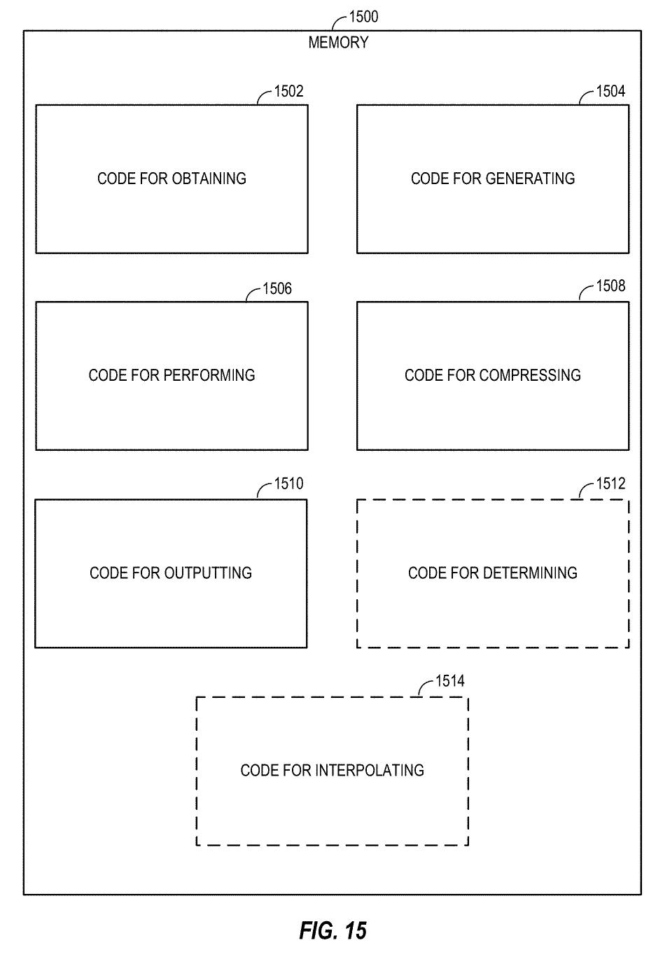

Referring to FIG. 15, programming stored by the memory 1500 (e.g. a storage medium, a memory device, etc.), when executed by a processing system (e.g., the processing system 1204 of FIG. 12), causes the processing system to perform one or more of the various functions and/or process operations described herein. For example, the programming, when executed by the processing system 1204, may cause the processing system 1204 to perform the various functions, steps, and/or processes described herein with respect to FIGS. 1-6, and 12-14 in various implementations. As shown in FIG. 15, the memory 1500 may include one or more of code for obtaining 1502, code for generating 1504, code for performing 1506, code for compressing 1508, code for outputting 1510, code for determining 1512, or code for interpolating 1514. In some aspects, one of more of the code for obtaining 1502, the code for generating 1504, the code for performing 1506, the code for compressing 1508, the code for outputting 1510, the code for determining 1512, or the code for interpolating 1514 may be executed or otherwise used to provide the corresponding functionality described herein for FIG. 14. In some aspects, the memory 1500 may correspond to the memory 1206 of FIG. 12.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner Also, unless stated otherwise a set of elements may comprise one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
a first interface configured to obtain at least one signal from a channel;
a processing system configured to:
generate a channel matrix from the at least one signal,
perform a singular value decomposition operation on the channel matrix to generate singular vectors, wherein the singular value decomposition operation involves:
generating a channel correlation matrix based on the channel matrix,
selecting a particular Givens rotation from a plurality of Givens rotations, and
rotating a particular iteration of the channel correlation matrix, wherein the selection of the particular Givens rotation involves ensuring that all rotations of all iterations of the channel correlation matrix, including the particular iteration, are in the same direction and further wherein the rotation of the particular iteration is based on the particular Givens rotation, and
compress the singular vectors to generate a set of angles; and
a second interface configured to output the set of angles for transmission.

2. (canceled)

3. The apparatus of claim 1, wherein the selection comprises comparing a first magnitude of a first diagonal element of the particular iteration of the channel correlation matrix with a second magnitude of a second diagonal element of the particular iteration of the channel correlation matrix.

4. The apparatus of claim 3, wherein the selection comprises:
selecting a first one of the plurality of Givens rotations if the comparison indicates that the first magnitude is less than the second magnitude; and
selecting a second one of the plurality of Givens rotations if the comparison indicates that the first magnitude is greater than or equal to the second magnitude.

5. The apparatus of claim 1, wherein the selection comprises selecting one of two solutions to a quadratic equation corresponding to the Givens rotations.

6. The apparatus of claim 1, wherein:
a first one of the plurality of Givens rotations comprises
$$[ \begin{matrix}cos ψ & sin ψ \\ - sin ψ & cos ψ\end{matrix} ] ;$$
and
a second one of the plurality of Givens rotations comprises
$$[ \begin{matrix}sin ψ & - cos ψ \\ cos ψ & sin ψ\end{matrix} ] .$$

7. The apparatus of claim 1, wherein the set of angles comprises sets of phi and psi values.

8. The apparatus of claim 1, wherein the set of angles has frequency coherence across a plurality of subcarriers of the channel.

9. The apparatus of claim 1, wherein the processing system is further configured to:
determine whether the channel is sufficiently coherent across a plurality of subcarriers of the channel;
interpolate between at least two angles of the set of angles across the subcarriers to generate at least one interpolated angle if the determination indicates that the channel is sufficiently coherent across the subcarriers; and
output the at least one interpolated angle for transmission.

10. A method of communication for an apparatus, comprising:
obtaining at least one signal from a channel;
generating a channel matrix from the at least one signal;
performing a singular value decomposition operation on the channel matrix to generate singular vectors, wherein the singular value decomposition operation involves:
generating a channel correlation matrix based on the channel matrix;
selecting a particular Givens rotation from a plurality of Givens rotations; and
rotating a particular iteration of the channel correlation matrix, wherein the selection of the particular Givens rotation involves ensuring that all rotations of all iterations of the channel correlation matrix, including the particular iteration, are in the same direction and further wherein the rotation of the particular iteration is based on the particular Givens rotation;
compressing the singular vectors to generate a set of angles; and
outputting the set of angles for transmission.

11. (canceled)

12. The method of claim 10, wherein the selection comprises comparing a first magnitude of a first diagonal element of the particular iteration of the channel correlation matrix with a second magnitude of a second diagonal element of the particular iteration of the channel correlation matrix.

13. The method of claim 12, wherein the selection comprises:
selecting a first one of the plurality of Givens rotations if the comparison indicates that the first magnitude is less than the second magnitude; and
selecting a second one of the plurality of Givens rotations if the comparison indicates that the first magnitude is greater than or equal to the second magnitude.

14. The method of claim 10, wherein the selection comprises selecting one of two solutions to a quadratic equation corresponding to the Givens rotations.

15. The method of claim 10, wherein:
a first one of the plurality of Givens rotations comprises
$$[ \begin{matrix}cos ψ & sin ψ \\ - sin ψ & cos ψ\end{matrix} ] ;$$
and
a second one of the plurality of Givens rotations comprises
$$[ \begin{matrix}sin ψ & - cos ψ \\ cos ψ & sin ψ\end{matrix} ] .$$

16. The method of claim 10, wherein the set of angles comprises sets of phi and psi values.

17. The method of claim 10, wherein the set of angles has frequency coherence across a plurality of subcarriers of the channel.

18. The method of claim 10, further comprising:
determining whether the channel is sufficiently coherent across a plurality of subcarriers of the channel;
interpolating between at least two angles of the set of angles across the subcarriers to generate at least one interpolated angle if the determination indicates that the channel is sufficiently coherent across the subcarriers; and
outputting the at least one interpolated angle for transmission.

19. A wireless node, comprising:
a receiver configured to receive at least one signal from a channel;
a processing system configured to:
generate a channel matrix from the at least one signal,
perform a singular value decomposition operation on the channel matrix to generate singular vectors, wherein the singular value decomposition operation involves:
generating a channel correlation matrix based on the channel matrix,
selecting a particular Givens rotation from a plurality of Givens rotations, and
rotating a particular iteration of the channel correlation matrix, wherein the selection of the particular Givens rotation involves ensuring that all rotations of all iterations of the channel correlation matrix, including the particular iteration, are in the same direction and further wherein the rotation of the particular iteration is based on the particular Givens rotation, and
compress the singular vectors to generate a set of angles; and
a transmitter configured to transmit the set of angles.

20-29. (canceled)
